(19) United States
(12) Patent Application Publication
(10) Pub. No.: US 2006/0185952 A1
(43) Pub. Date: Aug. 24, 2006

(54) Seal structure and shock absorber

(76) Inventor: Shigeru Kojima, Tokyo (JP)

Correspondence Address: RABIN & Berdo, PC, 1101 14TH STREET, NW, SUITE 500, WASHINGTON, DC, 20005, US

(21) Appl. No.: 11/346,446

(22) Filed: Feb. 3, 2006

(30) Foreign Application Priority Data
Feb. 18, 2005 (JP) 2005-41512

(51) Int. Cl. F16F 9/36

(52) U.S. Cl. 188/322.17

(57) ABSTRACT

A piston rod (3) is connected to a piston (2) in a cylinder (1) and projects axially from the cylinder (1). A rod guide (7) guiding the piston rod (3) in an axial direction and a ring shaped member (5) disposed in the vicinity of the rod guide (6) are respectively fixed to the cylinder (1). An oil seal (6) for the piston rod (3) comprises a flange portion (21) and a lip portion (20) projecting from the flange portion (21) so as to be in contact with the piston rod (3). By gripping the flange member (21) with the rod guide (7) and the ring shaped member (5), fitting and replacement of the oil seal (6) is facilitated. Further, by forming a space (25) in the rod guide (7) for housing the lip portion (20), stress occurring in the oil seal (6) can be suppressed.

### FIELD OF THE INVENTION

This invention relates to a seal structure between a cylinder and a rod inserted into the cylinder.

### BACKGROUND OF THE INVENTION

JPH11-063070A, JPH11-063071A published respectively in 1999 and JP2004-150581A published in 2004 by the Japan Patent Office disclose a seal structure between a piston rod and an opening of a cylinder in a hydraulic shock absorber.

The seal structure according to these prior art examples comprises a ring shaped member to which an oil seal and a dust lip, both of which are in contact with an outer circumference of the piston rod are fitted. A common base of the oil seal and dust lip is fixed to an inner circumference of the ring shaped member by deposition. The ring shaped member is put on a rod guide which is fixed to the cylinder in the vicinity of its opening. The ring shaped member is fixed to the cylinder by caulking the upper end of the cylinder inward or by welding the ring shaped member to the upper end of the cylinder.

### SUMMARY OF THE INVENTION

Since the specification of an oil seal depends on the specification of a hydraulic shock absorber, there may be a case where the hydraulic shock absorber requires a different oil seal. According to the seal structure of the prior arts, however, it is not possible to replace the oil seal because it is fixed to the ring shaped member by deposition.

In this seal structure, the base of the oil seal is fixed to the ring shaped member by deposition. The tip of the oil seal, i.e., an oil lip, bends due to a pressure in the cylinder or friction with the elongating/contracting piston rod. The bending takes place at a point corresponding to the inner circumference of the ring shaped member.

Since the oil seal bends in a narrow space between the ring shaped member and the piston rod, the bend angle is steep and great stress occurs in the oil seal.

It is therefore an object of this invention to enable replacement of an oil seal.

It is a further object of this invention to decrease the stress which occurs in an oil seal in contact with a rod.

In order to achieve the above objects, this invention provides a seal structure between a cylinder and a rod which projects axially from the cylinder, comprising a rod guide fixed to the cylinder for guiding the rod in an axial direction, a ring shaped member disposed adjacent to the rod guide and fixed to the cylinder, and an oil seal in contact with the rod.

The ring shaped member has an opening through which the rod penetrates. The oil seal comprises a flange portion which is gripped by the rod guide and the ring shaped member, and a lip portion projecting inward from the flange portion to be in contact with the rod.

This invention also provides a hydraulic shock absorber comprising a cylinder, a piston housed in the cylinder, a rod connected to the piston and projecting axially from the cylinder, a rod guide fixed to the cylinder for guiding the rod in an axial direction, a ring shaped member disposed adjacent to the rod guide and fixed to the cylinder, and an oil seal in contact with the rod.

The ring shaped member has an opening through which the rod penetrates. The oil seal comprises a flange portion which is gripped by the rod guide and the ring shaped member, and a lip portion projecting inward from the flange portion to be in contact with the rod.

The details as well as other features and advantages of this invention are set forth in the remainder of the specification and are shown in the accompanying drawings.

### BRIEF DESCRIPTION OF THE DRAWINGS

FIG. 1 is a longitudinal sectional view of a hydraulic shock absorber according to this invention.

FIG. 2 is a longitudinal sectional view of a seal structure according to this invention.

FIG. 3 is similar to FIG. 2, but shows another embodiment of this invention.

### DESCRIPTION OF THE PREFERRED EMBODIMENTS

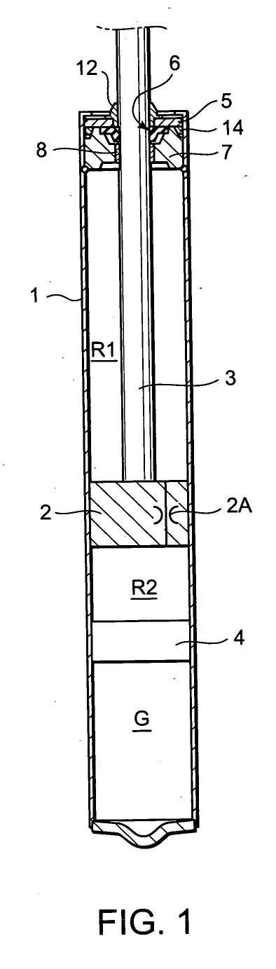

Referring to FIG. 1 of the drawings, a hydraulic shock absorber comprises a cylinder 1, a piston 2 housed in the cylinder 1 so as to be free to slide in an axial direction, a piston rod 3 connected to the piston 1 and projecting upward from the cylinder 1, and a free piston 4 housed in the cylinder 1 under the piston 2 so as to be free to slide.

A rod guide 7 which guides the piston rod 3 in the axial direction and a ring shaped member 5 that closes an upper end opening of the cylinder 1 are fixed to an upper end part of the cylinder 1. Wobbling of the piston rod 3 with respect to the cylinder 1 is prevented by the rod guide 7 and the piston 2.

The space in the cylinder 1 is divided by the free piston 4 into a lower gas chamber G land an upper liquid chamber. The liquid chamber is further divided by the piston 2 into an upper first operation chamber R1 and a lower second operation chamber R2. The inside of the first operation chamber R1 and the second operation chamber R2 is filled with working oil.

The piston 2 is provided with an orifice 2A which causes the first and second operation chambers R1, R2 to communicate with each other. Instead of providing an orifice, it is possible to provide any damping mechanism, e.g. a relief valve, that generates a similar damping force.

The gas chamber G is filled with air. As the shock absorber elongates and contracts, the piston rod 3 projects from the cylinder 1 or penetrates into the cylinder 1 such that the volume of the piston rod 3 in the cylinder 1 varies. In this situation, the free piston 4 moves upward or downward in the cylinder 1 to vary the capacity of the gas chamber G in order to keep the sum of the capacities of the operation chambers R1 and R2, i.e., the capacity of the liquid chamber, constant. A shock absorber of this type is classified as a single-tube shock absorber.

As the shock absorber elongates and contracts, the working oil moving between the first operating chamber R1 and the second operating chamber R2 through the orifice 2A suffers a pressure loss, and a damping force corresponding to the pressure loss is generated in the shock absorber.

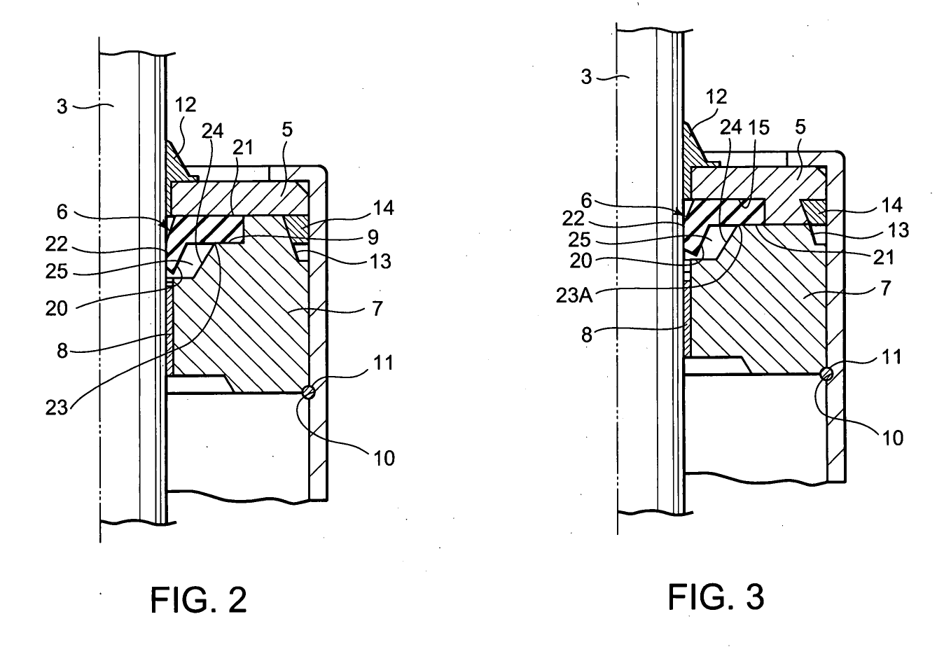

Next, referring to FIG. 2, the rod guide 7 is formed in a ring shape and its displacement downward is prevented by a snap ring 11 which is fitted in a groove 10 on the inner circumference of the cylinder 1. On the inner circumference of the rod guide 7, a bearing 8 is fixed to allow the piston rod 3 to slide in the axial direction. On an upper end face of the rod guide 7, a step 9 is formed along a circular path about the piston rod. An inclined surface 13 is formed on the outer side of the step 9 and an inclined surface 24 is formed on the inner side of the step 9. Due to the inclined surface 24, a ring shape space 25 around the piston rod 3 is formed within the rod guide 7.

The ring shaped member 5 is laminated onto the rod guide 7. After disposing the rod guide 7 and the ring shaped member 5, the open end of the cylinder 1 is caulked inward such that the ring shaped member 5 and the rod guide 7 are held between the caulked part and the snap ring 11 as shown the figure so as not to shift upward or downward.

On the inner circumference of the ring shaped member 5, a dust lip 12 made of rubber or resin is fixed by deposition such that its tip is in contact with the sliding piston rod 3. On the lower side of the outer circumference portion of the ring shaped member 5, another seal 14 made of rubber or resin is fixed by deposition. The seal 14 is formed to have a wedged cross section, and penetrates into a space formed by the inclined surface 13 of the rod guide 8 and the inner circumference of the cylinder 1.

In the space 25 formed by the inclined surface 24 of the rod guide 7 and the outer circumference of the piston rod 3, an oil seal 6 made of rubber or resin is disposed. The oil seal 6 comprises a lip portion 20 and a flange portion 21. The flange portion 21 has a thickness slightly greater than the depth of the step 9, and when it is gripped between the step 9 and the ring shaped member 5, it causes a slight deformation, thereby sealing entirely the space between the rod guide 7 and the ring shaped member 5.

With respect to the oil seal 6, the lip portion 20 slanting downward projects inward from the flange portion 21 such that its tip is in contact with the piston rod 3. The slanting angle and the horizontal length of the lip portion 20 is predetermined such that the lip portion 20 is in contact with the piston rod under an appropriate pressure.

The ring shaped member 5 functions to cover the upper end opening of the cylinder 1. The oil seal 6 and the seal 14 supported by the ring shaped member 5 assure the liquid tightness of the cylinder 1. Further, the introduction of dust and dirt into the cylinder 1 is blocked by the dust lip 12.

In this seal structure, when the oil seal 6 bends due to the pressure in the cylinder 1 or the friction with the sliding piston rod 3, it bends at a point corresponding to a border between the step 9 and the inclined surface 24 of the rod guide 7, or in other words, an inner end of the step 9, at a reflection point 23.

By forming a ring shaped space 25, the length from a contact point 22 of the lip portion 20 with the piston rod 3 to the reflecting point 23 can be set larger than that of the oil seal according to the prior art examples. By increasing this length, the bending stress occurring in the oil seal 6 is suppressed to be smaller than that occurring in the oil seal according to the prior art examples in relation to an identical bending amount.

By suppressing the bending stress, the durability of the oil seal 6 is enhanced. This seal structure is therefore suitable for use in a high pressure environment, e.g., in a shock absorber that requires a large damping force.

When the shock absorber is assembled, the oil seal 6 is automatically positioned concentrically with the piston rod 3 by the step 9 formed on the rod guide 7, and once it is positioned, its lateral displacement is prevented by the step 9. The lip portion 20 is therefore in contact with the piston rod 3 under even contact pressure on the entire circumference. As a result, the oil seal 6 exhibits a favorable sealing performance. It is unlikely that any part of the lip portion 20 will become worn or separate from the piston rod 3 such that sealing performance can no longer be maintained due to the eccentricity of the oil seal 6 with the piston rod 3.

Fitting of the oil seal 6 into the shock absorber is easy and may be completed simply, by gripping the oil seal 6 with the ring shaped member 5 and rod guide 7. Since no deposition is required in order to secure the oil seal 6 in the shock absorber, the oils seal 6 can be replaced easily. This characteristic of the oil seal 6 is useful when another type of oil seal is required for the same shock absorber depending on the specification required of the shock absorber.

Next, referring to FIG. 3, another embodiment of this invention will be described.

According to the first embodiment, the step 9 is formed in the rod guide 7, but according to this embodiment, a step 15 facing downward is formed in the ring shaped member 5. The step 9 is omitted and the rod guide 7 has a flat top surface. However, on both sides of the flat surface, the inclined surfaces 13 and 24 are formed in the rod guide 7 as in the case of the first embodiment.

According to this embodiment, the flange portion 21 of the oil seal 6 is gripped between the step 15 and the rod guide 7, and the step 15 automatically positions the oil seal 6 concentrically with the piston rod 3 when it is fitted into the shock absorber.

According to this embodiment also, the oil seal 6 bends at a reflecting point 23A, which is a border between the flat top surface and the inclined surface 24 of the rod guide 7. Both the reflecting point 23 and the reflecting point 23A correspond to the upper end of the inclined surface 24, and hence this embodiment also decreases the bending stress in the oil seal 6 as in the first embodiment. With respect to fitting of the oil seal 6 into the shock absorber or replacement thereof, this embodiment brings about a similarly preferable effect to the first embodiment.

The contents of Tokugan 2005-041512, with a filing date of Feb. 18, 2005 in Japan, are hereby incorporated by reference.

Although the invention has been described above by reference to certain embodiments of the invention, the invention is not limited to the embodiments described above. Modifications and variations of the embodiments described above will occur to those skilled in the art, within the scope of the claims.

For example, in the embodiments described above, this invention is applied to a hydraulic shock absorber, but this invention has a preferable effect when it is applied to a hydraulic cylinder. This invention can be applied to any seal structure for a rod projecting from or penetrating into a cylinder.

The embodiments of this invention in which an exclusive property or privilege is claimed are defined as follows:

What is claimed is:

1. A seal structure between a cylinder and a rod which projects axially from the cylinder, comprising:
a rod guide fixed to the cylinder for guiding the rod in an axial direction;
a ring shaped member disposed adjacent to the rod guide and fixed to the cylinder, the ring shaped member having an opening through which the rod penetrates; and
an oil seal in contact with the rod, the oil seal comprising a flange portion which is gripped by the rod guide and the ring shaped member, and a lip portion projecting inward from the flange portion to be in contact with the rod.

2. The seal structure as defined in claim 1, wherein the rod guide has a space facing the rod for housing the lip portion.

3. The seal structure as defined in claim 1, wherein the rod guide has a step on a surface facing the ring shaped member and the flange portion is gripped between the step and the ring shaped member.

4. The seal structure as defined in claim 1, wherein the ring shaped member has a step on a surface facing the rod guide and the flange portion is gripped between the step and the rod guide.

5. The seal structure as defined in claim 1, further comprising a dust lip fitted to the opening of the ring shaped member so as to be in contact with the rod and another seal fitted onto the outer circumference of the ring shaped member so as to be in contact with an inner circumference of the cylinder.

6. A hydraulic shock absorber comprising:
a cylinder;
a piston housed in the cylinder;
a rod connected to the piston and projecting axially from the cylinder;
a rod guide fixed to the cylinder for guiding the rod in an axial direction;
a ring shaped member disposed adjacent to the rod guide and fixed to the cylinder, the ring shaped member having an opening through which the rod penetrates; and
an oil seal in contact with the rod, the oil-seal comprising a flange portion which is gripped by the rod guide and the ring shaped member, and a lip portion projecting inward from the flange portion to be in contact with the rod.

7. The hydraulic shock absorber as defined in claim 6, wherein the rod guide has a space facing the rod for housing the lip portion.

8. The hydraulic shock absorber as defined in claim 6, wherein the rod guide has a step on a surface facing the ring shaped member and the flange portion is gripped between the step and the ring shaped member.

9. The hydraulic shock absorber as defined in claim 6, wherein the ring shaped member has a step on a surface facing the rod guide and the flange portion is gripped between the step and the rod guide.

10. The hydraulic shock absorber as defined in claim 6, further comprising a dust lip fitted to the opening of the ring shaped member so as to be in contact with the rod, and another seal fitted onto the outer circumference of the ring shaped member so as to be in contact with an inner circumference of the cylinder.
